(19) United States
(12) Patent Application Publication
(10) Pub. No.: US 2009/0225219 A1
(43) Pub. Date: Sep. 10, 2009

(54) IMAGE PICKUP SYSTEM

(76) Inventor: Kazunori ABE, Saitama (JP)

Correspondence Address: BIRCH STEWART KOLASCH & BIRCH, PO BOX 747, FALLS CHURCH, VA, 22040-0747, US

(21) Appl. No.: 12/400,644

(22) Filed: Mar. 9, 2009

(30) Foreign Application Priority Data
Mar. 10, 2008 (JP) 2008-059554

(51) Int. Cl. H04N 5/225

(52) U.S. Cl. 348/374; 348/E05.028

(57) ABSTRACT

An endoscope system is constituted of an electronic endoscope with a CCD, a processor device and a light source device. A CPU of the processor device detects which of a progressive scan CCD and an interlace scan CCD that the electronic endoscope is equipped with. In the case of the progressive scan CCD, an outputted progressive signal is directly inputted to an image processing circuit. In the case of the interlace scan CCD, an outputted interlace signal is converted into a progressive signal by an I/P converter, and then inputted to the image processing circuit.

### BACKGROUND OF THE INVENTION

1. Field of the Invention

The present invention relates to an image pickup system that is constituted of an image pickup device with a solid-state image sensor and a processor device detachably connected to the image pickup device.

2. Description Related to the Prior Art

An image pickup system, e.g. an endoscope system is constituted of an electronic endoscope (image pickup device) and a processor device detachably connected to each other. The electronic endoscope has a solid-state image sensor for capturing an image of a human body cavity. The processor device receives an image signal from the solid-state image sensor and produces an image, while controlling the actuation of the solid-state image sensor. As the solid-state image sensor of the electronic endoscope, a CCD (charge-coupled device) image sensor (hereinafter simply called CCD) is widely used.

The CCD is categorized in two, that is, an interlace scan CCD and a progressive scan CCD according to difference in a scan method. Conventionally, the processor device is designed compatibly with the scan method of the CCD that the connected electronic endoscope is equipped with. Thus, for example, an electronic endoscope with a progressive scan CCD is not connectable to an interlace scan processor device such as NTSC.

Accordingly, JPA 2000-287203 discloses an endoscope system having a processor device that is compatible with any electronic endoscope with a progressive scan CCD or an interlace scan CCD. The processor device is provided with a signal processing circuit including two image processing circuits compatible with each scan method.

In the foregoing endoscope system, however, the processor device retrieves the scan method of the CCD that the electronic endoscope is equipped with, and switches between the two image processing circuits in accordance with retrieval result. Therefore, this endoscope system requires the signal processing circuit of large size and high costs.

### SUMMARY OF THE INVENTION

An object of the present invention is to provide an image pickup system having a processor device that is a simple construction, while it is compatible with any of a progressive scan image sensor and an interlace scan image sensor.

To achieve the above object, a processor device composing an image pickup system according to the present invention comprises a scan method detector, an interlace-to-progressive converter and an image processing circuit. The scan method detector detects which of a progressive scan image sensor and an interlace scan image sensor a solid-state image sensor is. When the solid-state image sensor is the interlace scan image sensor, the interlace-to-progressive converter converts an interlace signal outputted from the solid-state image sensor into a first progressive signal. The image processing circuit carries out image processing on the first progressive signal converted by the interlace-to-progressive converter or a second progressive signal outputted from the progressive scan image sensor.

It is preferable that the image processing circuit carries out edge enhancement processing and color enhancement processing.

The processor device may further comprise an image memory for storing an output signal from the image processing circuit as image data, an image reader for reading the image data out of the image memory by progressive scanning or interlace scanning, and an output section for outputting the image data read by the image reader to the outside.

According to the image pickup system of the present invention, when the solid-state image sensor is the interlace scan image sensor, the interlace-to-progressive converter converts the interlace signal outputted from the solid-state image sensor into the progressive signal, and then the image processing circuit performs image processing on the progressive signal. Therefore, the image processing circuit that applies the image processing on any type of image signals irrespective of the type of the solid-state image sensor facilitates reduction in circuit size and costs.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a schematic perspective view of an endoscope system;

FIG. 2 is a front view showing a tip of an electronic endoscope;

FIG. 3 is a block diagram showing the structure of the endoscope system;

FIG. 4 is an explanatory view of a progressive scan method;

FIG. 5A is an explanatory view of an interlace scan method of an odd field;

FIG. 5B is an explanatory view of an interlace scan method of an even field; and

FIG. 6 is an explanatory view of an I/P conversion method.

### DESCRIPTION OF THE PREFERRED EMBODIMENTS

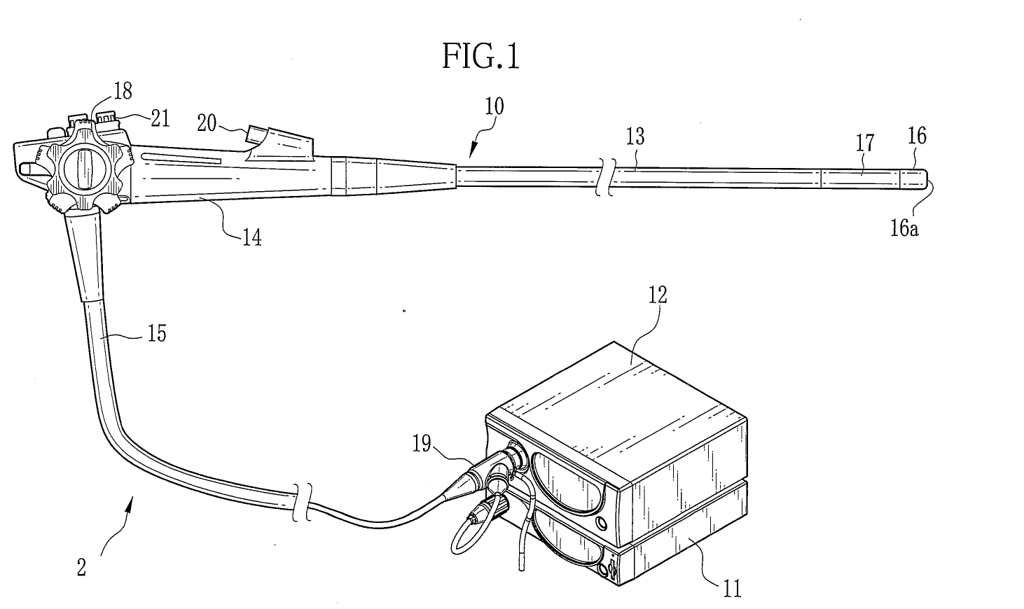

Referring to FIG. 1, an endoscope system 2 consists of an electronic endoscope 10, a processor device 11 and a light source device 12. The electronic endoscope 10 is provided with a flexible insert section 13 that is introduced into a human body cavity, an operation section 14 that is joined to a base end of the insert section 13, and a universal cord 15 that is connected to the processor device 11 and the light source device 12.

At an end of the insert section 13 is provided a distal portion 16 that contains a solid-state image sensor (CCD) 40 for capturing an optical image of a target body part to inspect. Behind the distal portion 16, a bending portion 17 consisting of a number of linked ring-like segments is provided. By operating an angle knob 18 on the operation section 14, a number of wires extending in the insert section 13 are pulled and pushed to flexibly bend the bending portion 17 from side to side and up and down. Thus, the distal portion 16 is directed to the target body part. The processor device 11 is electrically connected to the light source device 12 via the connector 19, and has control over the electronic endoscope 10 and the light source device 12. The light source device 12 supplies illumination light to the electronic endoscope 10.

A base end of the universal cord 15 is coupled to a multi-connector 19. The electronic endoscope 10 is connected to the processor device 11 and the light source device 12 via the connector 19.

The processor device 11 feeds power to the electronic endoscope 10 through a transmission cable extending in the universal cord 15, and controls the actuation of the CCD 40. The processor device 11 receives an image signal outputted from the CCD 40, and subjects the image signal to various kinds of signal processing to form image data. The processor device 11 converts an image data format suitably for connected external equipment such as a monitor and a recorder, and outputs the image data thereto.

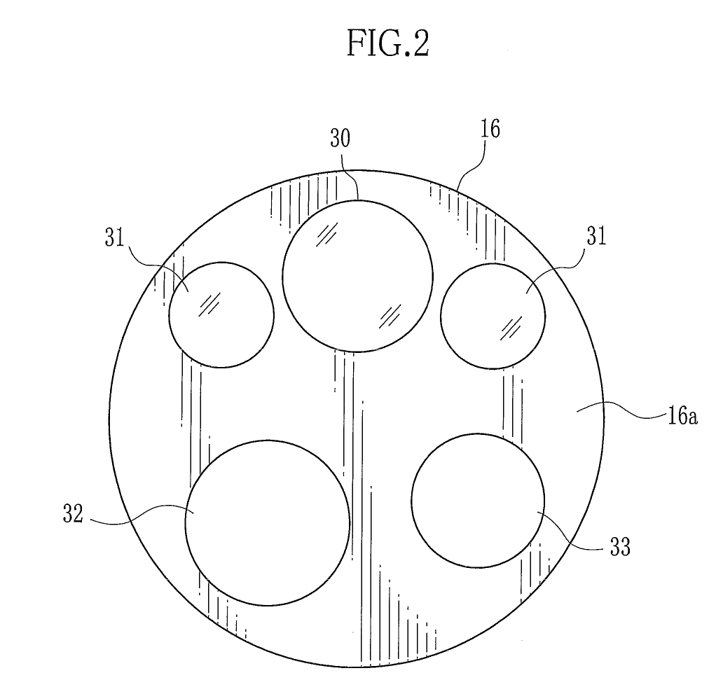

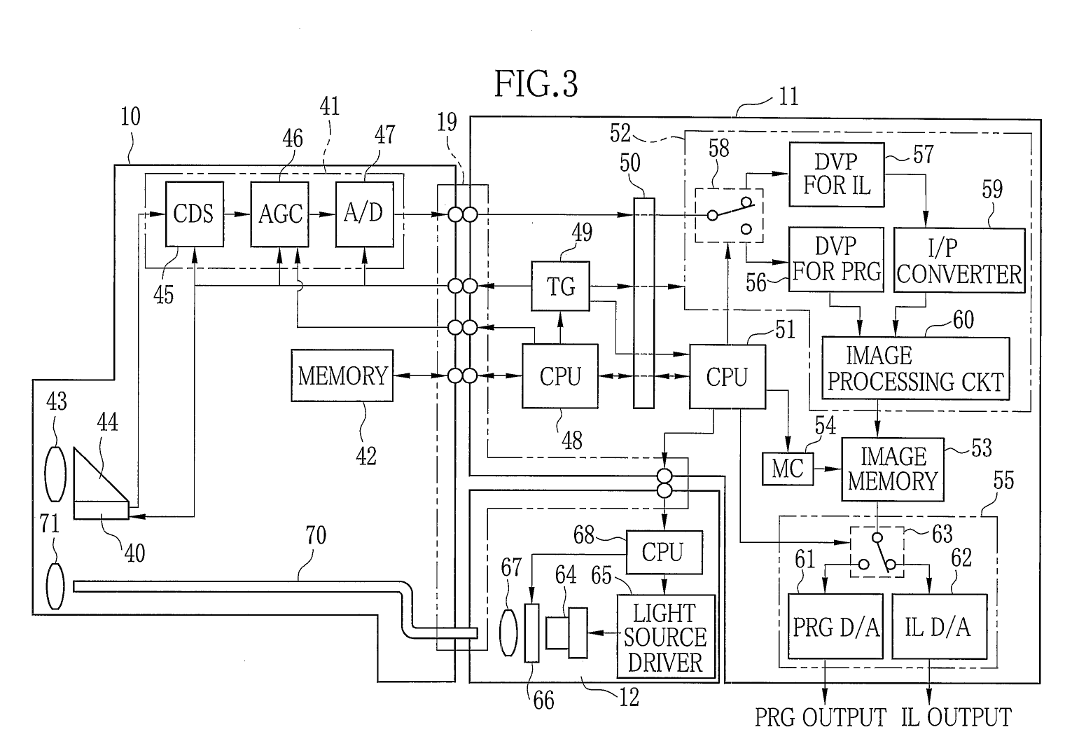

As shown in FIG. 2, a front face 16a of the distal portion 16 is provided with an image capturing window 30, lighting windows 31, a medical instrument outlet 32 and an airing/watering nozzle 33. The image capturing window 30 is disposed in the upper middle of the front face 16a. Behind the image capturing window 30, the CCD 40 is disposed through an objective lens system 43 and a prism 44 (refer to FIG. 3).

The two lighting windows 31 symmetric with respect to the image capturing window 30 projects illumination light that is guided from the light source device 12 through a light guide 70 (refer to FIG. 3) to the human body cavity. The medical instrument outlet 32 is connected to a medical instrument inlet 20 (refer to FIG. 1) through a channel extending in the insert section 13. A medical instrument with a needle, a diathermy knife or the like at its tip is inserted into the instrument inlet 20 in order to protrude the tip of the instrument from the instrument outlet 32 to the target body part.

The airing/watering nozzle 33 ejects water or air to the target body part in response to an operation on a airing/watering button 21 (refer to FIG. 1) on the operation section 14.

In FIG. 3, the endoscope 10 has the CCD 40 mounted in the distal portion 16, and an AFE (analog front end processor device) 41 and a memory 42 in the operation section 14. The CCD 40 is either a progressive scan CCD or an interlace scan CCD. The CCD 40 is so disposed that object light passing through the objective lens system 43 and the prism 44 is incident upon its light receiving surface. The light receiving surface is provided with a color filter including a plurality of color segments (for example, primary-colors filter of Bayer arrangement).

The AFE 41 includes a correlated double sampling circuit (CDS) 45, an automatic gain controller (AGC) 46 and an analog-to-digital converter (A/D) 47. The CDS 45 subjects the image signal outputted from the CCD 40 to correlated double sampling processing to remove reset noise and amplifier noise. Then, the AGC 46 amplifies the image signal by gain that the processor device 11 has designated. The A/D converter 47 converts the amplified image signal into a digital signal of a predetermined bit number, and inputs it to the processor device 11 through the connector 19.

The memory 42 stores distinction data for distinguishing the scan method of the CCD 40, that is, which of the progressive scan CCD and the interlace scan CCD the CCD 40 is. No sooner is the electronic endoscope 10 connected to the processor device 11, than the processor device 11 reads out the distinction data (identity data).

The processor device 11 includes a CPU 48, a timing generator (TG) 49, an isolation device (ID) 50, another CPU 51, a digital signal processing circuit (DSP) 52, an image memory 53, a memory controller (MC) 54 as an image reader and an output circuit 55. The CPU 48 controls the operation of the electric endoscope 10. The TG 49 generates various timing pulses. The ID 50 electrically separates the electric endoscope 10 from the processor device 11. The CPU 51 controls the operation of the processor device 11. The DSP 52 subjects the image signal to signal processing. The image memory 53 stores image data. The MC 54 controls the actuation of the image memory 53. The output circuit 55 converts the format of the image data stored on the image memory 53 suitably for external equipment and outputs.

Upon connecting the electric endoscope 10 to the processor device 11, the CPU 48 that functions as a scan method detector for detecting the scan method of the CCD 40 reads the distinction data stored on the memory 42. The CPU 48 drives the TG 49 on the basis of the detected scan method. The TG 49 generates drive pulses (a vertical/horizontal scanning pulse, a reset pulse and the like) for the CCD 40 and a synchronization pulse for the AFE 41 under the control of the CPU 48, and inputs them into the electric endoscope 10 through the connector 19.

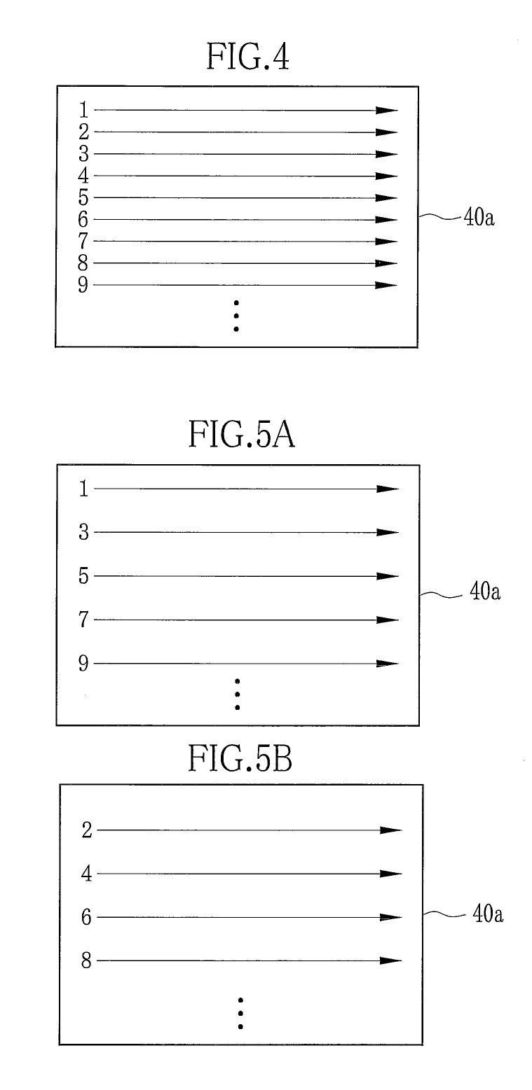

When the CCD 40 is the progressive scan CCD, as shown in FIG. 4, the TG 49 inputs the drive pulses to the CCD 40 for successively reading the whole horizontal lines (1, 2, 3 . . . ) of a single picture frame out of a pixel area 40a of the CCD 40. When the CCD 40 is the interlace scan CCD, on the other hand, the TG 49 inputs the drive pulses to the CCD 40 for alternately reading horizontal lines (1, 3, 5 . . . ) in an odd field shown in FIG. 5A and horizontal lines (2, 4, 6 . . . ) in an even field shown in FIG. 5B out of the pixel area 40a.

In the case of the progressive scan CCD, the frequency of the drive pulses is so set as to output the image signals of 60 frames per second. In the case of the interlace scan CCD, the frequency of the drive pulses is so set as to output the image signals of 60 fields per second.

The TG 49 also feeds a synchronization pulse for signal processing to the DSP 52 and the CPU 51 through the ID 50. The ID 50 is an isolator made of a photocoupler and the like. The image signal is inputted from the AFE 41 to the DSP 52 through the ID 50.

The DSP 52 includes a digital video processing circuit for the progressive scan CCD (hereinafter called DVP for PRG) 56, a digital video processing circuit for the interlace scan CCD (hereinafter called DVP for IL) 57, a selector 58 for selecting one of the DVP for PRG 56 and the DVP for IL 57, an interlace-to-progressive (I/P) converter 59 disposed subsequently to the DVP for IL 57, and an image processing circuit 60. The I/P converter 59 converts an interlace signal outputted from the DVP for IL 57 into a progressive signal. The image processing circuit 60 applies enhancement processing on the progressive signal, which is outputted from the DVP for PRG 56 or the I/P converter 59.

The image signal from the AFE 41 is inputted into the selector 58 through the ID 50. The CPU 51 communicates with the CPU 48 via the ID 50, and judges the scan method of the CCD 40. When the CCD 40 is the progressive scan CCD, the CPU 51 controls the selector 58 to input the image signal to the DVP for PRG 56. When the CCD 40 is the interlace scan CCD, on the other hand, the image signal is inputted into the DVP for IL 57.

The DVP for PRG 56 subjects the inputted progressive image signal to color separation, color interpolation, gain correction, white balance correction, gamma correction and the like, and converts the image signal into a YC signal consisting of a luminance signal (Y) and a chrominance signal (C). The DVP for IL 57, in a like manner, subjects the inputted interlace image signal to color separation, color interpolation, gain correction, white balance correction, gamma correction and the like, and converts the image signal into a YC signal.

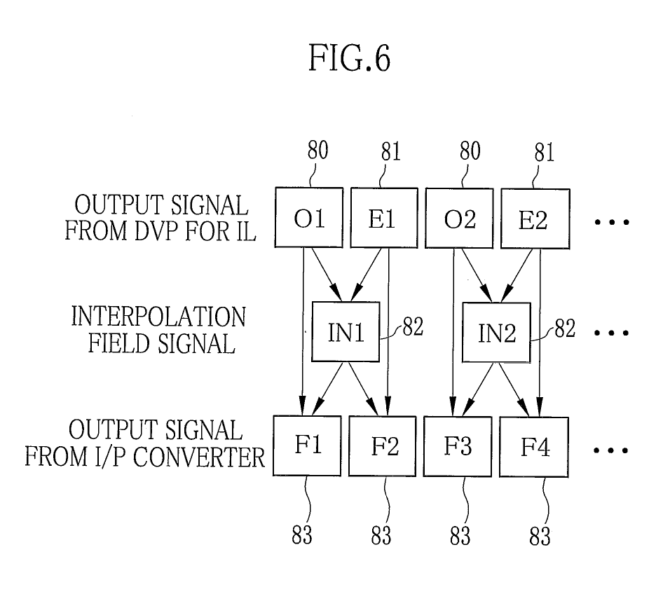

Of field signals (O1, E1, O2, E2 . . . ) outputted every 1/60 second from the DVP for IL 57, as shown in FIG. 6, the I/P converter 59 carries out interpolation processing on a pair of an odd field 80 and an even field 81 composing a single frame to generate an interpolation field 82. To be more specific, for example, subjecting the horizontal line (scanning line) No. 1 of the odd field 80 and the horizontal line (scanning line) No. 2 of the even field 81 to the interpolation processing generates a first horizontal line of the interpolation field 82. In the interpolation processing, the average of corresponding two pixels on the two horizontal lines Nos. 1 and 2 is obtained. Thus, the odd field signal O1 and the even field signal E1 form the interpolation field signal IN1, and the odd field signal O2 and the even field signal O2 form the interpolation field signal IN2.

Then, the odd field signal O1 and the interpolation field signal IN1 are combined to generate a frame signal F1 with a period of 1/60 second. Combining the even field signal E1 and the interpolation field signal IN1 generates a frame signal F2. Frame signals F3, F4 . . . are generated in a like manner.

In this combination processing, the interpolation field 82 is treated as the even field 81 when being combined with the odd field 80. The interpolation field 82 is treated as the odd field 80, when being combined with the even field 81. Accordingly, the output signals (frame signals) F1, F2 . . . from the I/P converter 59 have a progressive form, just as with the output signal from the DVP for PRG 56.

To the image processing circuit 60, the output signal from the DVP for PRG 56 or the output signal from the I/P converter 59 is inputted. Both of the signals are in the progressive form. The image processing circuit 60 subjects the signal to the enhancement processing such as edge enhancement and color enhancement, and successively inputs the enhanced frame signals into the image memory 53 as the image data.

The MC 54 controls image readout operation from the image memory 53. The MC 54 reads the image data out of the image memory 53 on the basis of a command of the CPU 51 by progressing scanning shown in FIG. 4 or interlace scanning shown in FIGS. 5A and 5B.

The output circuit 55 includes a progressive digital-to-analog converter (hereinafter called PRG D/A) 61, an interlace digital-to-analog converter (hereinafter called IL D/A) 62, and a selector for choosing between the PRG D/A 61 and the IL D/A 62.

The selector 63 chooses the PRG D/A 61 or the IL D/A 62 based on a command from the CPU 51. The CPU 51 controls the selector 63 to successively input the progressive signals (frame signals), which are read out of the image memory 53 by the progressive scanning, to the PRG D/A 61. The CPU 51 instead controls the selector 63 to successively input the interlace signals (field signals), which are readout of the image memory 53 by the interlace scanning, to the IL D/A 62.

The PRG D/A 61 converts the frame signal into an analog progressive signal. The IL D/A 62, on the other hand, converts the field signal into an analog interlace signal (NTSC or the like) To output terminals of the PRG D/A 61 and the IL D/A 62, external equipment such as a monitor and a recorder compatible with its signal form is connected.

The light source device 12 is composed of a light source 64 such as a xenon lamp and a halogen lamp, a light source driver 65 for driving the light source 64, an aperture stop mechanism 66 for adjusting the amount of light emitted from the light source 64, a condenser lens 67 disposed in front of the aperture stop mechanism 66, and a CPU 68 for controlling the light source driver 65 and the aperture stop mechanism 66 by communicating with the CPU 51. The condense lens 67 condenses light passing through the aperture stop mechanism 66, and leads it to an entry of the light guide 70. The light propagates through the light guide 70, and illuminates the target body part from the lighting windows 31 through a lens 71, as described above.

In observing the target body part by the endoscope system 2, the electronic endoscope 10 is first connected to the processor device 11 and the light source device 12 through the connector 19, and the processor device 11 and the light source device 12 are turned on. Then, a doctor inserts the insert section 13 of the electronic endoscope 10 into the human body cavity. The CCD 40 captures images of the target body part, while the light illuminates there through the lighting windows 31. Thus, the doctor observes the target body part with the monitor connected to the processor device 11.

Upon connecting the electronic endoscope 10 to the processor device 11, the CPU 48 of the processor device 11 reads the distinction data out of the memory 42 of the electronic endoscope 10 in order to detect which of the progressive scan CCD and the interlace scan CCD the electronic endoscope 10 is equipped with. The CPU 48 controls the TG 49 on the basis of the detected scan method and drives the CCD 40.

An image signal outputted from the CCD 40 is subjected to analog signal processing, and converted into a digital signal in the AFE 41. Then, the digital image signal is inputted into the processor device 11 through the connector 19. In the processor device 11, the image signal is inputted to the DSP 52, and to the DVP for PRG 56 or the DVP for IL 57 in accordance with the scan method detected by the CPU 48. In other words, the progressive image signal is inputted to the DVP for PRG 56, and the interlace image signal is inputted to the DVP for IL 57.

The image signal inputted to the DVP for PRG 56 is subjected to predetermined signal processing such as color separation, color interpolation, gain correction, white balance correction, gamma correction and the like. The image signal is then inputted to the image processing circuit 60 as a progressive YC signal. On the other hand, the image signal inputted to the DVP for IL 57 is also subjected to the predetermined signal processing such as color separation, color interpolation, gain correction, white balance correction, gamma correction and the like. The image signal is then inputted to the I/P converter 59 as an interlace YC signal. The I/P converter 59 converts the interlace YC signal into a progressive YC signal and inputs it to the image processing circuit 60. As a result, the progressive YC signal is inputted to the image processing circuit 60 irrespective of the type of the CCD 40.

The progressive YC signal is subjected to the enhancement processing in the image processing circuit 60, and is stored frame-by-frame on the image memory 53 as image data. The CPU 51 controls the MC 54 in accordance with the type of the external equipment connected to the processor device 11, and reads the image data out of the image memory 53 by the progressive scanning or the interlace scanning. The image data from the image memory 53 is inputted to the output circuit 55. The image data is converted into an analog progressive signal or interlace signal in the output circuit 55, and outputted to the external equipment.

According to the endoscope system 2, as described above, when the CCD 40 is the interlace scan CCD, the processor device 11 first converts the interlace image signal from the CCD 40 into a progressive form, and carries out the image processing by the image processing circuit 60. Therefore, obviating the need to provide a plurality of image processing circuits in accordance with the scan methods reduces circuit size and costs.

In the foregoing embodiment, the image processing circuit 60 subjects the progressive signal to enhancement processing. However, the present invention is not limited to it, the image processing circuit 60 may carry out characteristic extraction processing (text recognition) and the like in addition to the enhancement processing.

An I/P conversion method by the I/P converter 59 described above is just an example, and other methods are available.

The present invention has been explained by taking the endoscope system as an example of an image pickup system. The present invention, however, is applicable to any image pickup system such as an ultrasonic endoscope system which combines an electronic endoscope and an ultrasonic probe, a digital camera in which a lens barrel with image capturing function is detachable from a camera body having a display device such as a LCD, and a Web camera system which consists of a camera and a personal computer, as log as the image pickup system includes an image pickup device with a CCD and a processor device that are detachably connected to each other.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image pickup system including an image pickup device and a processor device, said image pickup device having a solid-state image sensor and being detachably connected to said processor device, said image pickup system comprising:
a scan method detector for detecting which of a progressive scan image sensor and an interlace scan image sensor said solid-state image sensor is;
an interlace-to-progressive converter for converting an interlace signal outputted from said interlace scan image sensor into a first progressive signal; and
an image processing circuit for carrying out image processing on said first progressive signal converted by said interlace-to-progressive converter, as with on a second progressive signal outputted from said progressive scan image sensor.

2. The image pickup system as recited in claim 1, wherein said processor device contains said scan method detector, said interlace-to-progressive converter and said image processing circuit.

3. The image pickup system as recited in claim 2, wherein said image processing circuit carries out edge enhancement processing and color enhancement processing.

4. The image pickup system as recited in claim 2, wherein said processor device further comprises:
an image memory for storing an output signal from said image processing circuit as image data;
an image reader for reading said image data out of said image memory by progressive scanning or interlace scanning; and
an output section for outputting said image data read by said image reader to the outside.

5. The image pickup system as recited in claim 2, wherein said scan method detector reads distinction data out of a memory of said image pickup device to detect a scan method of said solid-state image sensor.

6. The image pickup system as recited in claim 2, wherein said interlace-to-progressive converter forms an interpolation field from an odd field and an even field composing a single frame by interpolation processing, and combining said interpolation field with each of said odd field and said even field forms two frames of said first progressive signal.

7. The image pickup system as recited in claim 2, wherein said image pickup device is an electronic endoscope having said solid-state image sensor.

8. A processor device for producing an image from an image signal outputted from an endoscope, said endoscope having a solid-state image sensor, said processor device comprising:
a scan method detector for detecting which of a progressive scan image sensor and an interlace scan image sensor said solid-state image sensor is;
an interlace-to-progressive converter for converting an interlace signal outputted from said interlace scan image sensor into a first progressive signal; and
an image processing circuit for carrying out image processing on said first progressive signal converted by said interlace-to-progressive converter, as with on a second progressive signal outputted from said progressive scan image sensor.
